(19) United States
(12) Patent Application Publication
(10) Pub. No.: US 2008/0140336 A1
(43) Pub. Date: Jun. 12, 2008

(54) DIGITAL GAS METER

(76) Inventor: William HOME, Taipei City (TW)

Correspondence Address: LEONG C LEI, PMB # 1008, 1867 YGNACIO VALLEY ROAD, WALNUT CREEK, CA, 94598, US

(21) Appl. No.: 11/567,209

(22) Filed: Dec. 6, 2006

(51) Int. Cl. G01K 13/00

(52) U.S. Cl. 702/130

(57) ABSTRACT

A digital gas meter which includes a CPU programmed with conversion relationship between environmental temperature and gas pressure inside a gas tank, a pressure sensor for detecting pressure of gas in a gas tank, a temperature sensor for detecting environment temperature, a power source connected with the CPU to supply power to the CPU, and a display unit, whereby the temperature sensor is arranged outside a gas tank for detecting environmental temperature and transmitting the environment temperature to the CPU, the pressure sensor detects gas pressure inside the gas tank and transmits the gas pressure to the CPU, the CPU compares the environmental temperature detected by the temperature sensor and the pressure picked up by the pressure sensor with data pre-stored therein and automatically analyzes comparing results, and after analyzing, the CPU returns a precise gas measurement to the display unit to show the amount of gas left in the gas tank.

### BACKGROUND OF THE INVENTION

(a) Technical Field of the Invention

This invention relates to a digital gas meter, with the attempt to provide a more accurate measurement for the amount of gas contained in a gas tank. This invention can pick up the pressure of the gas left in the gas tank, as well as the temperature outside the gas tank. These measurements are then compared with the data pre-stored in a CPU (central processing unit) arranged inside the digital gas meter, where the CPU will automatically analyze the measurements collected. After the analyzing process, the CPU will return a precise gas measurement that overcomes the problems of inaccurate measurement due to pressure difference produced by temperature variations.

(b) Description of the Prior Art

Because the amount of gas left in the gas tank is not visible to users, gas tank users usually have difficulties in determining the amount of gas left. Without being able to determine the amount left in the gas tank, the gas tank replacement may not be ordered in time. Failure to order the gas tank in time may result in users having problems with cooking or to continue their work. For users residing in remote or suburban areas, it's even harder for them to obtain a replacement gas tank from neighborhood without pre-ordering.

The present technology focuses on the conveniences of use, where an analog indicating gauge is located beside the opening valve of the gas tank. The analog indicating gauge has a needle on the device surface which displays the gas pressure inside the gas tank and indicates the level of the amount of gas left. As illustrated in FIG. 1, the conventional gas meter 40 is connected with an adaptor 20 and simply utilizes a pressure mechanism to indicate the pressure in a gas tank. Then, the pressure measurement is directly converted into volume measurement to show the amount of gas volume left in the gas tank. However, the gas meter 40 cannot precisely reflect the actual gas volume remaining in the gas tank due to temperature variations. Gas pressure inside the gas tank varies in accordance with the temperature variation. At a temperature of 5° C., if the gas pressure inside the gas tank is about 64 psig, the gas meter needle will show a medium level of gas volume. Under the same circumstances, holding the actual gas volume left unchanged, if the temperature goes down to 0° C., the gas pressure will condense to about 52 psig. The lowering of the gas pressure detected pushes the gas volume indication down to a low level. This will mislead gas tank users into believing that the gas tank is running low in volume, while in fact the users still have plenty of time before purchasing a new gas tank. On the other hand, when the temperature goes up from low temperature, the high level indication of the gas volume inside the gas tank will cause the gas tank users to be too optimistic about the actual gas amount left. This may be a major problem of concern for travelers who travel across hot and cold areas via a camper.

Therefore, it is an object of the present invention to provide an improved gas meter which can obviate and mitigate the above-mentioned drawbacks.

### SUMMARY OF THE INVENTION

This invention is related to a digital gas meter which can accurately show the amount of gas left in the gas tank.

It is the primary object of the present invention to provide a digital gas meter which includes a CPU programmed with conversion relationship between environmental temperature and gas pressure inside a gas tank, a pressure sensor for detecting pressure of gas in a gas tank, a temperature sensor for detecting environment temperature, a power source connected with the CPU to supply power to the CPU, and a display unit, whereby the temperature sensor is arranged outside a gas tank for detecting environmental temperature and transmitting the environment temperature to the CPU, the pressure sensor detects gas pressure inside the gas tank and transmits the gas pressure to the CPU, the CPU compares the environmental temperature detected by the temperature sensor and the pressure picked up by the pressure sensor with data pre-stored therein and automatically analyzes comparing results, and after analyzing, the CPU returns a precise gas measurement to the display unit to show gas amount left in the gas tank.

The foregoing object and summary provides only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 illustrates a prior art gas meter;

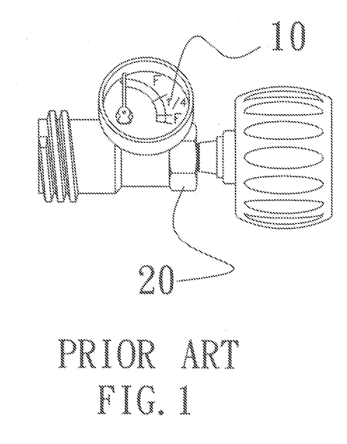

FIG. 2 is a block diagram according to a preferred embodiment of the present invention;

FIG. 3 is a top plan view of the digital gas meter according to the present invention; and

FIG. 4 is a working view of the digital gas meter according to the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

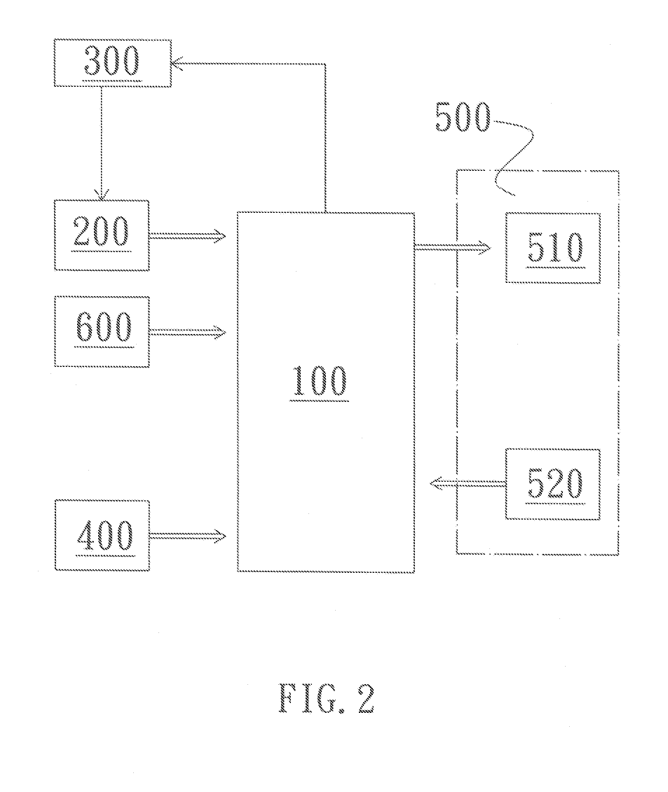

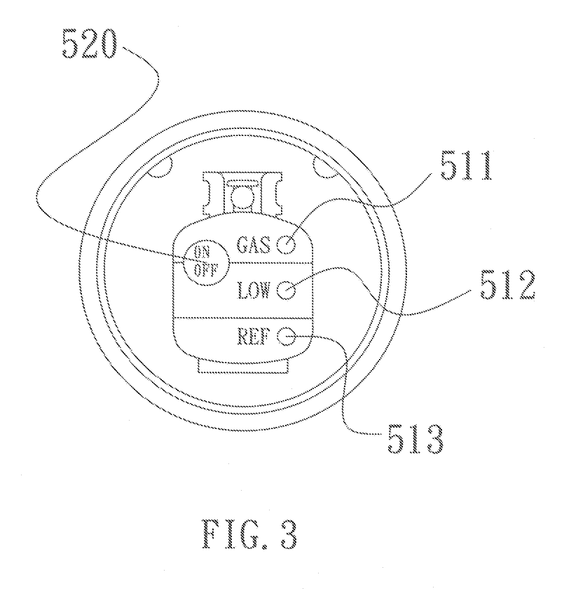

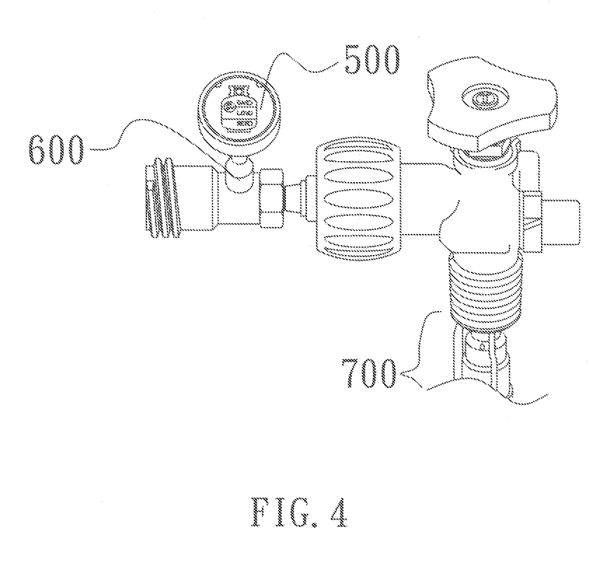

Referring to FIGS. 2, 3 and 4, the digital gas meter according to the present invention comprises a CPU (central processing unit) 100, a pressure sensor 200, a current and voltage control unit 300, a power source 400, a display unit 500 and a temperature sensor 600. The digital gas meter is connected with an adaptor engaged with a valve assembly 700. The CPU is programmed with the conversion relationship between environmental temperature and gas pressure inside a gas tank. The temperature sensor 600 is arranged outside a gas tank for detecting the environmental temperature which is then transmitted to the CPU 100. The pressure sensor 200 detects the pressure inside the gas tank which is ten transmitted to the CPU 100. The CPU 100 will compare the temperature detected by the temperature sensor 600 and the pressure picked up by the pressure sensor 200 with the data pre-stored therein and will then automatically analyze the measurements collected. After the analyzing process, the CPU 100 will return a precise gas measurement to the display unit 500 to show the gas amount left in the gas tank.

The current and voltage control unit 300 is connected between the CPU 100 and the pressure sensor 200. The display unit 500 includes a display 510 and an on/off switch 520 which are connected to the CPU 100 respectively. The display 510 includes a first LED 511, a second LED 512 and a third LED 513. The first LED 511 is used for indicating that the gas amount in the gas tank is at a high level so that the user may use the gas to cook or the like at ease. The second LED 512 is used for indicating that the gas amount in the gas tank is at a low level. The third LED 513 is used for reminding the user of refilling the gas.

The display 510 may be replaced with an LCD screen to show the gas amount left in the gas tank in digital numbers, or a loudspeaker to show the gas amount left in the gas tank with voice messages.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A digital gas meter comprising:
a CPU programmed with conversion relationship between environmental temperature and gas pressure inside a gas tank
a pressure sensor for detecting pressure of gas in a gas tank and connected with said CPU;
a temperature sensor for detecting environment temperature and connected with said CPU;
a power source connected with said CPU to supply power to said CPU
a display unit connected with said CPU;
whereby said temperature sensor is arranged outside a gas tank for detecting environmental temperature which is then transmitted to said CPU, said pressure sensor detects gas pressure inside said gas tank which is then transmitted to said CPU, said CPU compares said environmental temperature detected by said temperature sensor and said pressure picked up by said pressure sensor with data pre-stored in said CPU and automatically analyzes comparing results, and after analyzing, said CPU will return a precise gas measurement to said display unit to show gas amount left in said gas tank.

2. The digital gas meter as claimed in claim 1, further comprising a current and voltage control unit connected to said CPU.

3. The digital gas meter as claimed in claim 1, wherein said displaying unit comprises a display and an on/off switch which are connected to said CPU.

4. The digital gas meter as claimed in claim 3, wherein said display comprises a first LED for indicating the amount of gas in said gas tank is at a high level, a second LED for indicating that the amount of gas in the gas tank is at a low level, and a third LED for reminding the user of refilling the gas in said gas tank.

5. The digital gas meter as claimed in claim 3, wherein said display is an LCD screen.

6. The digital gas meter as claimed in claim 3, wherein said display is replaced with a loudspeaker.
